(19) United States
(12) Patent Application Publication
(10) Pub. No.: US 2023/0334980 A1
(43) Pub. Date: Oct. 19, 2023

(54) METHOD FOR PREDICTING TRAFFIC INFORMATION, APPARATUS FOR PREDICTING TRAFFIC INFORMATION, AND STORAGE MEDIUM STORING INSTRUCTIONS TO PERFORM METHOD FOR PREDICTING TRAFFIC INFORMATION

(71) Applicant: Research & Business Foundation SUNGKYUNKWAN UNIVERSITY, Suwon-si (KR)

(72) Inventors: Jae Wook JEON, Suwon-si (KR); Long Hoang PHAM, Suwon-si (KR); Hyung Min JEON, Suwon-si (KR); Duong Nguyen Ngoc TRAN, Suwon-si (KR)

(73) Assignee: Research & Business Foundation SUNGKYUNKWAN UNIVERSITY, Suwon-si (KR)

(21) Appl. No.: 18/133,630

(22) Filed: Apr. 12, 2023

(30) Foreign Application Priority Data
Apr. 15, 2022 (KR) 10-2022-0047198

(51) Int. Cl. G06V 20/54; G08G 1/056; G08G 1/017; G06V 20/58; G08G 1/01; G06V 20/40

(52) U.S. Cl. CPC G08G 1/0125; G06V 20/46; G06V 20/54; G06V 20/58; G08G 1/0112; G08G 1/0116; G08G 1/0145; G08G 1/017; G08G 1/056

(57) ABSTRACT

A method of predicting traffic information includes receiving a road image photographed by a vehicle that is moved on a road, and detecting an object for the vehicle from a plurality of frames included in the road image; tracking the object detected in the plurality of frames; checking a movement trajectory of the tracked object, and checking a movement direction corresponding to the movement trajectory of the object; and checking a number of vehicles for each movement direction on the basis of the checked movement direction.

### TECHNICAL FIELD

The present disclosure relates to a method for predicting traffic flow information and an apparatus for performing the method.

This work was supported by Institute of Information & communications Technology Planning & Evaluation (IITP) grant funded by the Korea government(MSIT) (Project unique No.: 1711152837; Project No.: 2021-0-01364-002; R&D project: SW Computing Industry Source Technology Development Project; and Research Project Title: (SW Star Lab) Development of Continuous Real-time Intelligent Traffic Monitoring System on Edge Devices) and National Research Foundation of Korea(NRF) grant funded by the Korean Government (Ministry of Science and ICT) (Project unique No.: 1711161755; Project No.: 2020R1A2C3011286; R&D project: Mid-sized Enterprise Research; and Research Project Title: Development of Real-time Scene Understanding Technology in Complex Traffic Conditions and Severe Weather).

### BACKGROUND ART

Generally, a device for determining traffic information is a system including a device (e.g. CCTV camera, etc.) that collects traffic condition information (e.g. video information) and a server device that receives and analyzes this piece of information (e.g. video information). Such a conventional system is configured such that the server device analyzes images provided from a plurality of devices (e.g. CCTV camera, etc.), detects various objects included in the images according to the analyzed result, and analyzes traffic conditions therefrom. However, since video data received from the plurality of devices (e.g. CCTV camera, etc.) connected to the system should be processed, an environment capable of processing massive data is required.

### DISCLOSURE

### Technical Problem

There is a problem in that a system implemented by focusing on the above-described conventional server device requires a high-performance computing resource, a large-capacity memory resource, a high-speed communication network, and the like, so that a lot of cost is consumed in constructing the system. In order to solve this problem, it is necessary to construct a system for predicting traffic information, which can replace the system implemented by focusing on the server device.

The present disclosure is to provide an apparatus and method for predicting traffic information using an edge computing device that is provided adjacent to a camera for capturing a road image.

Technical objects to be achieved by the present disclosure are not limited to the aforementioned technical objects, and other technical objects not described above may be evidently understood by a person having ordinary skill in the art to which the present disclosure pertains from the following description.

### Technical Solution

In accordance with an aspect of the present disclosure, there is provided a method of predicting traffic information, the method comprises: receiving a road image photographed by a vehicle that is moved on a road, and detecting an object for the vehicle from a plurality of frames included in the road image; tracking the object detected in the plurality of frames; checking a movement trajectory of the tracked object, and checking a movement direction corresponding to the movement trajectory of the object; and checking a number of vehicles for each movement direction on the basis of the checked movement direction.

In accordance with another aspect of the present disclosure, there is provided an apparatus of predicting traffic information, the apparatus comprises: a camera device capturing a road image in which a vehicle moving on a road is included; a memory storing one or more instructions; and a processor executing the one or more instructions stored in the memory, wherein the instructions, when executed by the processor, cause the processor to receive the road image and detecting an object for the vehicle from a plurality of frames included in the road image, track the object detected in the plurality of frames, check a movement trajectory of the tracked object and checking a movement direction corresponding to the movement trajectory of the object, and check a number of vehicles for each movement direction on the basis of the checked movement direction.

### Advantageous Effects

In accordance with the embodiment of the present disclosure, it is possible to detect information required to predict traffic information in an edge computing environment having a low-performance computing resource and a small-capacity memory resource.

Further, an apparatus may be operated in real time to provide traffic information such as figures or statistics to a control center online at low communication cost, by detecting and providing traffic information from an edge computing device adjacent to a camera.

Further, the size of data transmitted to a server device can be reduced by detecting information required to predict traffic information from an edge computing device adjacent to a camera and providing the information to the server device that manages the traffic information.

Further, traffic information can be stably provided, and the cost of installing and maintaining a system can be significantly reduced even in an environment where no high-performance communication network is constructed, by reducing the size of data transmitted from an edge computing device adjacent to a camera to a server device.

### DESCRIPTION OF DRAWINGS

FIG. 1 is a diagram illustrating the configuration of a traffic information management system to which an apparatus for predicting traffic information according to an embodiment of the present disclosure is applied.

FIG. 2 is a block diagram illustrating the apparatus for predicting traffic information according to an embodiment of the present disclosure.

FIG. 3 is a block diagram conceptually illustrating the function of a traffic information prediction program according to an embodiment of the present disclosure.

FIG. 4 is a diagram illustrating an observation zone that is set in an object tracking unit of the traffic information prediction program according to an embodiment of the present disclosure.

FIGS. 5A and 5B are diagrams illustrating an example of a movement direction and an MOI trajectory used in the traffic information prediction program according to an embodiment of the present disclosure.

FIGS. 6A and 6B are diagrams illustrating another example of a movement direction and an MOI trajectory used in the traffic information prediction program according to an embodiment of the present disclosure.

FIG. 7 shows a procedure included in a method of predicting traffic information according to an embodiment of the present disclosure.

FIG. 8 is a diagram illustrating an operation of tracking an object using an observation zone by the traffic information predicting method according to an embodiment of the present disclosure.

### MODE FOR DISCLOSURE

The above and other objectives, features, and advantages of the present disclosure will be easily understood from the following preferred embodiments in conjunction with the accompanying drawings. However, the present disclosure may be embodied in different forms without being limited to the embodiments set forth herein. Rather, the embodiments disclosed herein are provided to make the disclosure thorough and complete and to sufficiently convey the spirit of the present disclosure to those skilled in the art. The scope of the present disclosure is merely defined by the claims.

In the following description of the present disclosure, detailed descriptions of known functions and configurations which are deemed to make the gist of the present disclosure obscure will be omitted. Since the terms can be differently defined according to the intention of a user or an operator or customs, these terms should be interpreted as having a meaning that is consistent with the technical spirit of the present disclosure.

The functional blocks shown in the drawings and described below are only possible implementations. Other functional blocks may be used in other implementations without departing from the spirit and scope of the detailed description. In addition, while one or more functional blocks of the present disclosure are represented as individual blocks, one or more of the functional blocks of the present disclosure may be a combination of various hardware and software configurations that perform the same function.

Further, the expression “certain components are included” simply indicates that corresponding components are present, as an open expression, and should not be understood as excluding additional components.

Furthermore, it should be understood that when an element is referred to as being “coupled” or “connected” to another element, it can be directly coupled or connected to the other element or intervening elements may be present therebetween.

Further, it will be understood that the terms “first”, “second”, etc. are used herein to distinguish one element from another element, these terms do not limit the order or other features between the elements.

Hereinafter, the embodiments of the present disclosure will be described with reference to the accompanying drawings.

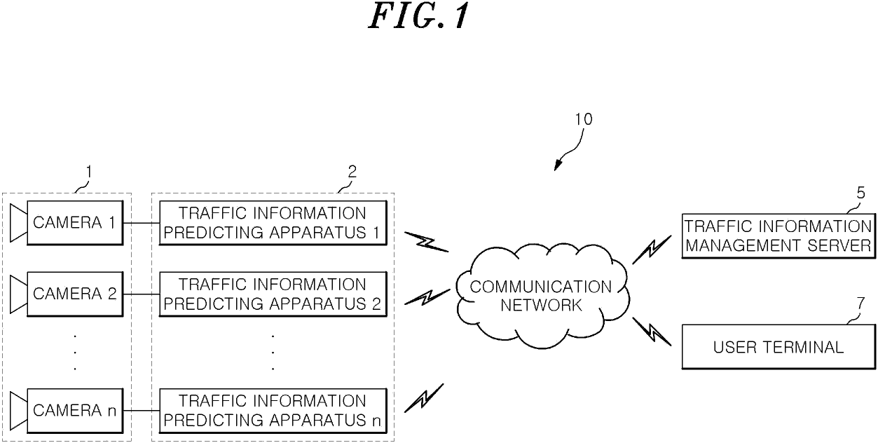

FIG. 1 is a diagram illustrating the configuration of a traffic information management system to which an apparatus for predicting traffic information according to an embodiment of the present disclosure is applied.

Referring to FIG. 1, the traffic information management system 10 includes a plurality of cameras 1, a plurality of traffic information predicting apparatuses 2, a traffic information management server 5, and a user terminal 7.

The camera 1 may be installed around a road on which a vehicle is moving, and may store and provide an image captured by the vehicle moving on the road.

The traffic information predicting apparatus 2 may be connected to the camera 1, and may analyze an image provided from the camera 1 to predict traffic information. As an example, the traffic information predicting apparatus 2 may be physically integrated with the camera 1 to form a single device. As another example, the traffic information predicting apparatus 2 may be configured as a device separate from the camera 1, and may be configured to receive an image captured by the camera 1 through wired or wireless communication.

In particular, the traffic information predicting apparatus 2 may detect a vehicle object from the image, and may analyze traffic information on the basis of the detected vehicle object. The traffic information predicting apparatus 2 may include a pre-learned artificial neural network model that detects the vehicle object from the image, and may be configured to input an image frame of the image captured by the camera 1 into the pre-learned artificial neural network model and to detect the vehicle object as an output thereof. Preferably, the pre-learned artificial neural network model may be configured to be processed by an edge computing device having few resources.

Further, the traffic information predicting apparatus 2 may check a movement trajectory by tracking the detected vehicle object, and may check and provide the number of vehicles moving on the road on the basis of the movement trajectory of the vehicle object. Specifically, the traffic information predicting apparatus 2 may track or manage the movement trajectory of the detected vehicle object by matching it with a predetermined MOI (Movement of Interest). At this time, since various types of roads or intersections may be present in the environment where the vehicle is moving, the MOI may be preset according to the type of the road or the type of the intersection. For instance, a two-lane road may include a first MOI indicating a first direction (e.g. up-line direction), and a second MOI indicating a second direction (e.g. down-line direction) that is opposite to the first direction. Thus, the traffic information predicting apparatus 2 installed at a corresponding road may determine the movement trajectory of the detected vehicle object as the first MOI or the second MOI. As another example, there are access roads in four directions on a four-way intersection, and each access road in the intersection allows a vehicle to enter in three directions (turn left, go straight, and turn right). Therefore, a total of 12 MOIs may be present on the road of the four-way intersection, and the traffic information predicting apparatus 2 may determine the movement trajectory of the detected vehicle object as one of 12 MOIs.

Further, the traffic information predicting apparatus 2 may check the movement direction of the vehicle according to the MOI determined to conform to the shape of the road or intersection. As an example, the traffic information predicting apparatus 2 may check the number of vehicles for each movement direction and then provide it to the traffic information management server 5.

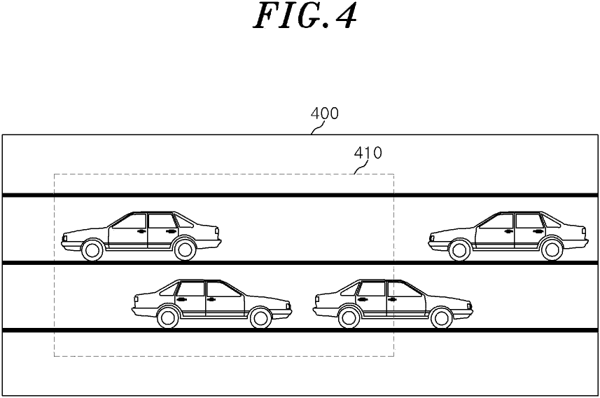

Moreover, an operation in which the traffic information predicting apparatus 2 determines the number of vehicles for each movement direction will be described in detail in the operation description of the traffic information predicting apparatus described below with reference to FIGS. 4, 5A, 5B, 6A, and 6B.

Meanwhile, the traffic information management server 5 may store and manage traffic information, and may establish an environment capable of providing the managed traffic information through a wired/wireless communication network 3. For instance, the traffic information management server 5 may store traffic information for each specific location, and may receive a traffic information request for the specific location. As an example, within the environment of the traffic information management server 5 acting as the server and the user terminal 7 acting as a client, the user terminal 7 may be loaded with a traffic information check application configured to receive the specific location from a user and to request the traffic information corresponding to that location to the traffic information management server 5. Correspondingly, the traffic information management server 5 may be configured to check the requested traffic information of a specific location and provide the traffic information to the user terminal 7, and the user terminal 7 may be configured to provide the received traffic information of the specific location through the traffic information check application to the user. Here, the traffic information may include information such as traffic volume or traffic congestion.

In particular, the traffic information management server 5 may be connected to the plurality of traffic information predicting apparatuses 2 through the wired/wireless communication network 3, receive the number of vehicles for each movement direction from the traffic information predicting apparatus 2, and generate traffic information using the received number of vehicles for each movement direction. To this end, the traffic information management server 5 may manage an identifier of the traffic information predicting apparatus capable of identifying the plurality of traffic information predicting apparatuses 2, and may store and manage installation location information about a location where the traffic information predicting apparatus 2 is installed. Correspondingly, the traffic information management server 5 may generate traffic information about a corresponding road on the basis of the installation location information by reflecting the number of vehicles for each movement direction received from the plurality of traffic information predicting apparatuses 2.

On the other hand, as another example, the traffic information predicting apparatus 2 may be configured to generate traffic information using the number of vehicles for each movement direction and provide the traffic information to the traffic information management server 5. To this end, the traffic information predicting apparatus 2 may store and manage installation location information about the location where it is installed. Further, the traffic information predicting apparatus 2 may generate traffic information about a corresponding road on the basis of the installation location information by reflecting the number of vehicles for each movement direction. Furthermore, the traffic information predicting apparatus 2 may provide the generated traffic information to the traffic information management server 5.

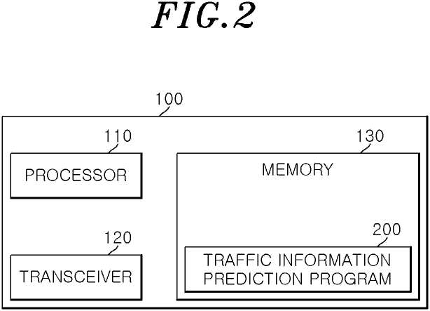

FIG. 2 is a block diagram illustrating the apparatus for predicting traffic information according to an embodiment of the present disclosure.

Referring to FIG. 2, a traffic information predicting apparatus 200 may include a processor 210, a transceiver 220, and a memory 230.

The processor 210 may control the overall operation of the traffic information predicting apparatus 200.

The processor 210 may receive an image captured by the camera 1. As an example, the camera 1 may be configured as a device separate from the traffic information predicting apparatus 200. Correspondingly, the processor 210 may acquire the image received from the camera 1 through the transceiver 220. As another example, the camera 1 may be configured to be installed in the traffic information predicting apparatus 200. Correspondingly, the processor 210 may acquire the image captured by the camera 1.

The memory 230 may store the traffic information prediction program 300 and information required to execute the traffic information prediction program 300.

Herein, the traffic information prediction program 300 may mean software including commands that are programmed to generate traffic information on the basis of the vehicle object included in the image.

As an example, the traffic information prediction program 300 may be configured to be executed in a single device of the traffic information predicting apparatus 2. For example, the traffic information predicting apparatus 2 may check the number of vehicles for each movement direction on the basis of the vehicle object included in the image, and generate traffic information on the basis of the number of vehicles for each movement direction. As another example, the traffic information prediction program 300 may be provided to be executed in conjunction with the traffic information predicting apparatus 2 and the traffic information management server 5. By a command loaded in the traffic information predicting apparatus 2, the number of vehicles for each movement direction may be checked on the basis of the vehicle object included in the image, and the checked number of vehicles for each movement direction may be provided to the traffic information management server 5. By a command loaded in the traffic information management server 5, the traffic information may be generated on the basis of the number of vehicles for each movement direction.

The processor 210 may load the traffic information prediction program 300 and information required to execute the traffic information prediction program 300 in the memory 230 so as to execute the traffic information prediction program 300.

The processor 210 may execute the traffic information prediction program 300 to generate the traffic information.

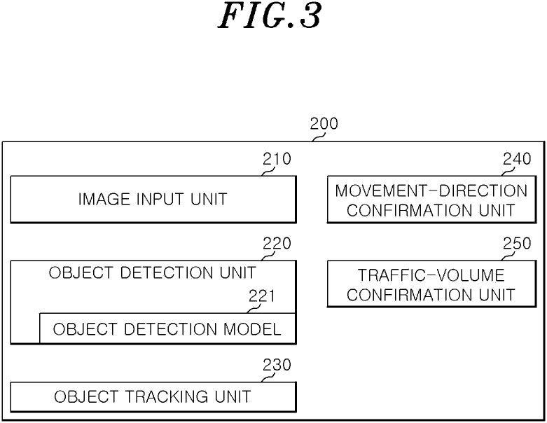

The function and/or operation of the traffic information prediction program 300 will be described in detail with reference to FIG. 3.

FIG. 3 is a block diagram conceptually illustrating the function of the traffic information prediction program according to an embodiment of the present disclosure.

Referring to FIGS. 2 and 3, the traffic information prediction program 300 may include an image input unit 310, an object detection unit 320, an object tracking unit 330, a movement-direction confirmation unit 340, and a traffic-volume confirmation unit 350.

The image input unit 310, the object detection unit 320, the object tracking unit 330, the movement-direction confirmation unit 340, and the traffic-volume confirmation unit 350 shown in FIG. 3 conceptually divide the function of the traffic information prediction program 300 so as to easily explain the function of the traffic information prediction program 300, and the present disclosure is not limited thereto. According to embodiments, respective functions of the image input unit 310, the object detection unit 320, the object tracking unit 330, the movement-direction confirmation unit 340, and the traffic-volume confirmation unit 350 may be merged with/separated from each other, and implemented as a series of commands included in one program.

The image input unit 310 may receive an image (hereinafter referred to as a “road image”) captured by the vehicle moving on the road from the camera, and temporarily store the received road image so as to predict traffic information. For instance, the road image may include an image generated at 24 fps (frames per second) or 30 fps. Correspondingly, an image including 24 or 30 frames per second may be stored. Moreover, the number of frames of the road image stored by the image input unit 310 may be set in consideration of the computing resource and memory resource of the apparatus. As an example, the road image captured for 5 seconds may be temporarily stored. As another example, the image input unit 310 may selectively store some frames of the road image in consideration of the computing resource and memory resource of the apparatus. For instance, when the road image is an image including 24 or 30 frames per second, the image input unit 310 may extract and store one frame in the unit of 2 or 3 frames.

Moreover, the image input unit 310 may store and manage the road image by matching it with an identification number of the traffic information predicting apparatus or an identification number of the camera, and the identification number of the traffic information predicting apparatus or the identification number of the camera may be managed in conjunction with the location of the traffic information predicting apparatus or camera. Therefore, the location of the traffic information predicting apparatus or camera may be confirmed through the identification number of the traffic information predicting apparatus or the identification number of the camera. Although, in an embodiment of the present disclosure, the location of the traffic information predicting apparatus or camera may be confirmed using the identification number of the traffic information predicting apparatus or the identification number of the camera, the present disclosure may be variously changed and used without being limited thereto. For instance, when the image input unit 310 stores the road image, the identification number of the traffic information predicting apparatus or the identification number of the camera may be stored and managed using information indicating the location of the traffic information predicting apparatus or the location of the camera.

The object detection unit 320 may detect the object from the frame of the above-described road image, using an object detection model 231. The object detection model 231 may be a machine learning model that takes the road image as an input and outputs object information about the vehicle included in the image. Thus, the object detection model 231 may include a pre-learned deep learning network to output object information corresponding to the input of the road image. For instance, the object detection unit 320 may input each frame of the road image input from the image input unit 310 into the object detection model 231, and the object detection model 231 may detect a zone where the object of the vehicle is present from each frame of the road image. Further, the object detection model 231 may output information (e.g. the coordinate value of an object existence zone, etc.) indicating a zone in which the object of the vehicle is present.

Since the traffic information predicting apparatus 200 according to an embodiment of the present disclosure generates traffic information in the environment of the edge computing device having a small computing resource and a small capacity of memory, it is preferable to implement the object detection model 231 in the environment of the edge computing device.

Moreover, the characteristics of traffic flow may be differently exhibited depending on the type of the vehicle moving on the road. As an example, since the traffic flow generated by a general vehicle such as a car or a truck may be different from the traffic flow generated by a large vehicle equipped with a trailer, it is necessary to analyze the traffic flow by reflecting the type of vehicle so as to increase the accuracy of the traffic information. Therefore, the object detection model 231 may be configured to further confirm and provide the vehicle type of the detected object.

Additionally, the object detection unit 320 may perform pre-processing on the frame of the above-described road image. For instance, the object detection unit 320 may perform pre-processing tasks such as noise filtering, re-sizing, and batching on the frame of the road image.

The object tracking unit 330 may check information provided for each frame of the road image by the object detection unit 320, e.g. a zone where the object of the vehicle exists, and may track the object of the vehicle on the basis of the checked information. The object detection unit 320 checks the zone where the object of the vehicle exists for each frame of the road image, and provides information about the zone. On the basis of this information, the object tracking unit 330 may check the object for each frame, and may manage an object identified in a current frame to match it with a pre-detected object in a previous frame or manage it as a new object, by matching the same objects between frames.

Moreover, the object tracking unit 330 may track the object throughout the frame of the road image, but it is necessary to minimize a resource for tracking an object so that the traffic information prediction program may be driven in the environment of the edge computing device. In view of that, the object tracking unit 330 may be configured to set an observation zone in the frame of the road image and track the object entering the observation zone.

FIG. 4 is a diagram illustrating the observation zone that is set in the object tracking unit of the traffic information prediction program according to an embodiment of the present disclosure.

FIG. 4 illustrates an observation zone 410 that is set in a frame 400 of the road image. At this time, the observation zone 410 may be set on the basis of a road area where a vehicle object is moved within the frame 400.

Referring to FIGS. 3 and 4, the object tracking unit 330 may check whether the object entering the observation zone 410 is detected over a predetermined number of frames, and assign an identifier (hereinafter referred to as a “tracking ID”) for tracking the object that is detected over the predetermined number of frames. Further, the object tracking unit 330 may check the location of a corresponding object within the observation zone 410 of a plurality of frames, and store the checked locations using the tracking ID.

Turning back to FIG. 3, the movement-direction confirmation unit 340 may confirm a movement trajectory using the locations of the stored object using the tracking ID, and confirm a movement direction that is fit for the movement trajectory. Specifically, the movement-direction confirmation unit 340 may configure the movement trajectory by connecting the locations of the object included in each tracking ID, and check the length of the configured movement trajectory. Further, the movement-direction confirmation unit 340 may compare the length of the movement trajectory with a predetermined threshold value, and determine the movement direction on the basis of the compared result. As an example, when the length of the movement trajectory exceeds the predetermined threshold value, the movement-direction confirmation unit 340 may determine the movement direction on the basis of the MOI (Movement of Interest) trajectory (hereinafter referred to as a “MOI trajectory based determining method”). When the length of the movement trajectory does not exceed the predetermined threshold value, namely, when the length of the movement trajectory is equal to or less than the predetermined threshold value, the movement-direction confirmation unit 340 may determine the movement direction on the basis of a MOI zone (hereinafter referred to as a “MOI zone-based determination method”).

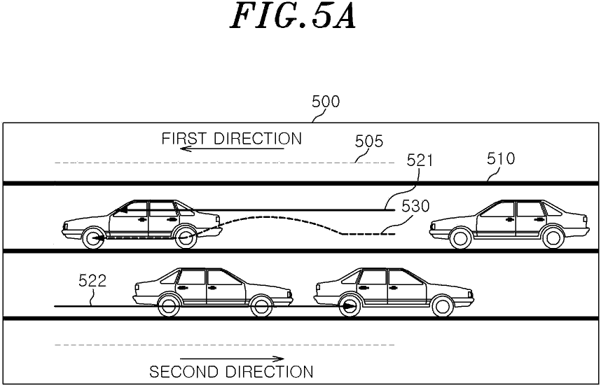

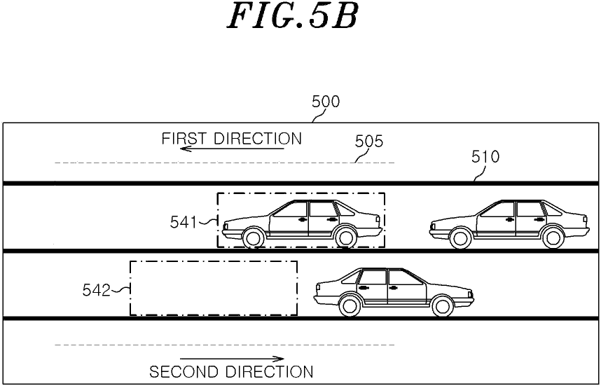

FIGS. 5A and 5B are diagrams illustrating an example of the movement direction and the MOI trajectory used in the traffic information prediction program according to an embodiment of the present disclosure.

Referring to FIG. 5A, a road image 500 photographing a two-lane road 510 is illustrated, and an observation zone 505 may be set in the road image 500. The two-lane road 510 may include a first MOI trajectory 521 indicating a first direction (e.g. up-line direction), and a second MOI trajectory 522 indicating a second direction (e.g. down-line direction) that is opposite to the first direction. Further, it illustrates that a movement trajectory 530 of the object is detected in the road image 500. Here, the first MOI trajectory 521 may be formed by calculating an average value of trajectories along which a plurality of vehicle objects passing in the first direction (e.g. up-line direction) are moved. Likewise, the second MOI trajectory 522 may be formed by calculating an average value of trajectories along which a plurality of vehicle objects passing in the second direction (e.g. down-line direction) are moved.

Referring to FIG. 5B, the observation zone 505 may be set in the road image 500 photographing the two-lane road 510. The vehicle object may be moved in the first direction (e.g. up-line direction) or the second direction (e.g. down-line direction) on the two-lane road 510, and a first MOI zone 541 corresponding to the first direction (e.g. up-line direction) and a second MOI zone 542 corresponding to the second direction (e.g. down-line direction) may be set.

Referring to FIGS. 3 and 5A, the movement-direction confirmation unit 340 may compare the length of the movement trajectory 530 of the object with a predetermined threshold value, and determine the movement direction using the MOI trajectory-based determination method, as the length of the movement trajectory 530 exceeds a predetermined threshold value. That is, the movement-direction confirmation unit 340 may calculate a difference value (e.g. Hausdorff distance value) between the movement trajectory 530 and the first MOI trajectory 521, and a difference value between the movement trajectory 530 and the second MOI trajectory 522. Further, the movement-direction confirmation unit 340 may set a MOI trajectory having a relatively small difference value among two difference values, and determine the movement direction corresponding to the set MOI trajectory.

On the other hand, when the length of the movement trajectory 530 does not exceed the predetermined threshold value, the movement-direction confirmation unit 340 may determine the movement direction through the MOI zone-based determination method. For instance, the movement-direction confirmation unit 340 may confirm which MOI zone the object is located in the observation zone 505, and determine the movement trajectory. Specifically, referring to FIG. 5B, the first MOI zone 541 and the second MOI zone 542 may be included in the observation zone 505. As the object is present in the first MOI zone 541, the movement-direction confirmation unit 340 may determine the movement direction of the corresponding object as a direction corresponding to the first MOI zone 541.

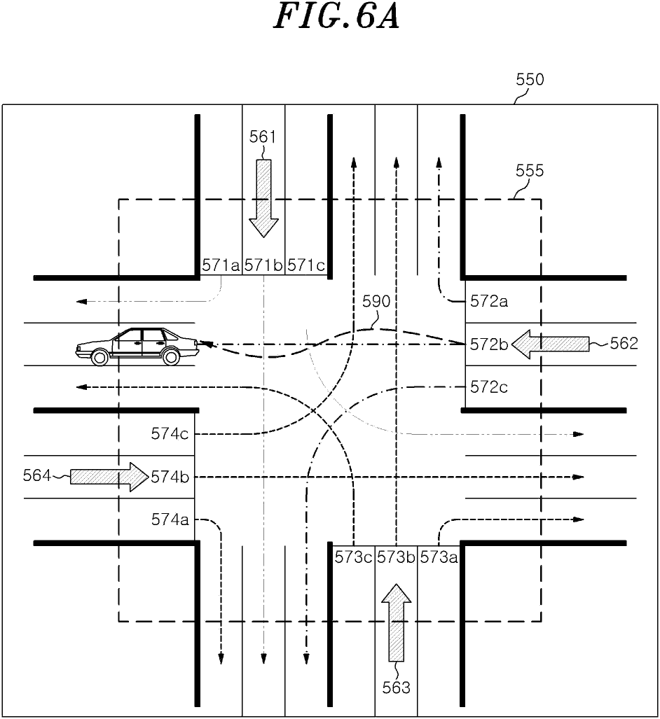

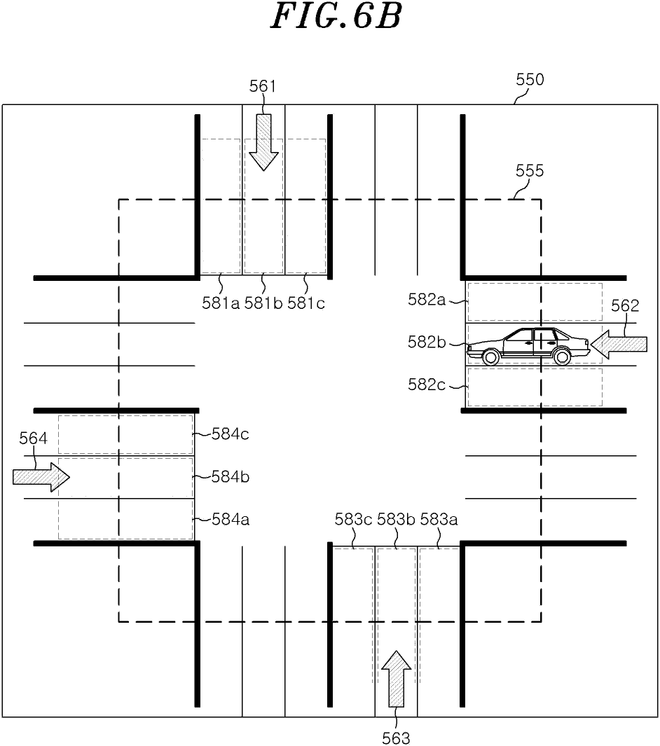

FIGS. 6A and 6B are diagrams illustrating another example of a movement direction and an MOI trajectory used in the traffic information prediction program according to an embodiment of the present disclosure.

Referring to FIG. 6A, a road image 550 photographing a road at a four-way intersection may be illustrated. There are access roads 561, 562, 563, and 564 in four directions on the road at the four-way intersection, and each access road in the intersection allows a vehicle to enter in three directions (turn left, go straight, and turn right). Therefore, a total of 12 MOI trajectories 571a, 571b, 571c, 572a, 572b, 572c, 573a, 573b, 573c, 574a, 574b, and 574c may be present in the road image 550 photographing the road at the four-way intersection. Here, the MOI trajectories 571a, 571b, 571c, 572a, 572b, 572c, 573a, 573b, 573c, 574a, 574b, and 574c may be configured by calculating an average value of trajectories along which a plurality of vehicle objects passing in each direction are moved.

Similarly to FIG. 6A, referring to FIG. 6B, the road image 550 photographing the road at the four-way intersection may be illustrated. There are access roads 561, 562, 563, and 564 in four directions on the road at the four-way intersection. In order for the vehicle object to pass through the intersection from the access roads 561, 562, 563, and 564 in four directions, the vehicle should enter and pass in one of three travel directions (turn left, go straight, and turn right) from each access road. Therefore, the vehicle object may pass through zones passing in three travel directions (turn left, go straight, and turn right) from each of the four access roads 561, 562, 563, and 564. In this regard, MOI zones 581a, 581b, 581c, 582a, 582b, 582c, 583a, 583b, 583c, 584a, 584b, and 584c for the travel directions (turn left, go straight, and turn right) from each of the access roads 561, 562, 563, and 564 may be present in the road image 550 photographing the road of the four-way intersection.

Referring to FIGS. 3 and 6A, the movement-direction confirmation unit 340 may compare the length of the movement trajectory 590 of the object with a predetermined threshold value. Further, as the length of the movement trajectory 590 exceeds the predetermined threshold value, the movement-direction confirmation unit 340 may determine the movement direction through the MOI trajectory-based determining method. That is, the movement-direction confirmation unit 340 may calculate difference values between the movement trajectory 590 and 12 MOI trajectories 571a, 571b, 571c, 572a, 572b, 572c, 573a, 573b, 573c, 574a, 574b, and 574c. Subsequently, the movement-direction confirmation unit 340 may compare difference values for 12 trajectories, set an MOI trajectory having the smallest difference value, and determine a movement direction corresponding to the set MOI trajectory.

On the other hand, when the length of the movement trajectory 530 does not exceed the predetermined threshold value, the movement-direction confirmation unit 340 may determine the movement direction through the MOI zone-based determination method. That is, the movement-direction confirmation unit 340 may confirm which MOI zone the object is located in an observation zone 555, and determine the movement direction. For instance, 12 MOI zones may be included in the observation zone 555. As a target object is present in a fifth MOI zone 582b, the movement-direction confirmation unit 340 may determine the movement direction of the corresponding object as a direction corresponding to the fifth MOI zone 582b.

As such, the movement-direction confirmation unit 340 may confirm the movement trajectory using the locations of the stored object using the tracking ID, and confirm the movement direction that is fit for the movement trajectory.

Turning back to FIGS. 3 and 4, the traffic-volume confirmation unit 350 may calculate the traffic volume by counting the number of vehicles moving in a corresponding direction, on the basis of the movement direction provided by the movement-direction confirmation unit 340. At this time, the traffic-volume confirmation unit 350 may count the number of vehicles moved with respect to the observation zone 410. Specifically, the movement trajectory of the object for the vehicle may be tracked in the observation zone 410, and the number of corresponding objects may be counted with respect to time when they leave the observation zone 410. As such, by counting the number of the corresponding objects with respect to time when they leaves the observation zone 410, i.e. by counting the number of the objects in a state where the movement trajectory or the movement direction within the observation zone 410 has been confirmed, counting errors may be reduced. Further, by reducing the number of the objects being counted in a state where the movement direction has not been confirmed, it is possible to prevent unnecessary computing resources or memory capacity from being used for counting the number of the objects.

The traffic-volume confirmation unit 350 may store and provide the number of vehicles for each movement direction. For instance, there may be a device (e.g. traffic information management server, etc.) that processes traffic information using the number of vehicles for each movement direction and provides a traffic information service on the basis of the processed information, and the traffic-volume confirmation unit 350 may provide the number of vehicles for each movement direction using the above-described device (e.g. traffic information management server, etc.).

Although it is illustrated in an embodiment of the present disclosure that the traffic-volume confirmation unit 350 confirms the number of vehicles for each movement direction and provides the number of vehicles for each movement direction to the above-described device (e.g. traffic information management server, etc.), the present disclosure may be variously changed without being limited thereto. For instance, the traffic-volume confirmation unit 350 may calculate traffic congestion using a result obtained by counting the number of vehicles for each movement direction. Further, the traffic-volume confirmation unit 350 may provide the calculated traffic congestion to the above-described device (e.g. traffic information management server, etc.).

Moreover, the traffic-volume confirmation unit 350 may provide the number of vehicles for each movement direction as well as the type of vehicle, and the traffic-volume confirmation unit 350 or the device for providing the traffic information service may process the traffic information in consideration of both the number of vehicles for each movement direction and the type of vehicle.

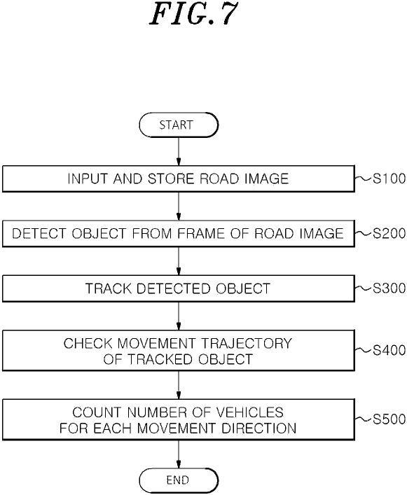

FIG. 7 shows a procedure included in a method of predicting traffic information according to an embodiment of the present disclosure. The method of predicting the traffic information shown in FIG. 7 may be performed by the traffic information predicting apparatus 200 shown in FIG. 2.

In addition, since the procedure constituting the method shown in FIG. 7 is merely exemplary, the spirit of the present disclosure is not limited to the method shown in FIG. 7 or the procedure constituting the method, and is not limited to the order of procedures constituting the method shown in FIG. 7.

Referring to FIGS. 7 and 2, an operation of storing an image (hereinafter referred to as a “road image”) captured by a vehicle moving on a road may be performed (S100). Here, the road image may include an image generated at 24 fps (frames per second) or 30 fps. Correspondingly, an image including 24 or 30 frames per second may be stored.

Moreover, the number of frames of the road image stored in step S100 may be set in consideration of the computing resource and memory resource of the apparatus. As an example, the road image captured for 5 seconds may be temporarily stored. As another example, the image frame stored in step S100 may select some frames of the road image in consideration of the computing resource and memory resource of the apparatus. For instance, when the road image is an image including 24 or 30 frames per second, one frame may be extracted and stored in the unit of 2 or 3 frames.

Moreover, when the road image is stored in step S100, an identification number of the traffic information predicting apparatus or an identification number of the camera may be matched and then stored and managed, and the identification number of the traffic information predicting apparatus or the identification number of the camera may be managed in conjunction with the location of the traffic information predicting apparatus or camera. Therefore, the location of the traffic information predicting apparatus or camera may be confirmed through the identification number of the traffic information predicting apparatus or the identification number of the camera. Although, in an embodiment of the present disclosure, the location of the traffic information predicting apparatus or camera may be managed to be confirmed using the identification number of the traffic information predicting apparatus or the identification number of the camera, the present disclosure may be variously changed and used without being limited thereto.

In step S200, the object may be detected from the frame of the above-described road image. In order to detect the object, the object detection model 231 may be used. Here, as described above, the object detection model 231 may be a machine learning model that is trained to take the road image as an input and to output object information about the vehicle included in the image. Thus, the object detection model 231 may include a pre-learned deep learning network to output object information corresponding to the input of the road image. Thus, in step S200, the frame of the road image may be input into the object detection model 231, and correspondingly, the object detection model 231 may detect and output information (e.g. the coordinate value of an object existence zone, etc.) about a zone where the object for the vehicle is present from each frame of the road image.

Since the traffic information predicting apparatus 200 according to an embodiment of the present disclosure generates traffic information in the environment of the edge computing device having a small computing resource and a small capacity of memory, it is preferable to implement the object detection model 231 in the environment of the edge computing device.

Moreover, the characteristics of traffic flow may be differently exhibited depending on the type of the vehicle moving on the road. As an example, since the traffic flow generated by a general vehicle such as a car or a truck may be different from the traffic flow generated by a large vehicle equipped with a trailer, it is necessary to analyze the traffic flow by reflecting the type of vehicle so as to increase the accuracy of the traffic information. Therefore, the object detection model 231 may be configured to further confirm and provide the vehicle type of the detected object.

Additionally, the traffic information predicting method may further perform a pre-processing operation S150 on the frame of the above-described road image. For instance, the traffic information predicting method may perform pre-processing tasks such as noise filtering, re-sizing, and batching on the frame of the road image, before inputting the frame of the road image into the object detection model 231.

In step S300, the object for the vehicle may be tracked using information provided for each frame of the road image, e.g. the zone where the object for the vehicle exists. For instance, in step S300, an object identified in a current frame may be managed to be matched with a pre-detected object in a previous frame or be managed as a new object, by matching the same objects between frames.

Moreover, in step S300, the object may be tracked throughout the frame of the road image, but it is necessary to minimize a resource for tracking an object so that the traffic information prediction program may be driven in the environment of the edge computing device. In view of that, in step S300, an observation zone may be set in the frame of the road image and the object entering the observation zone may be tracked.

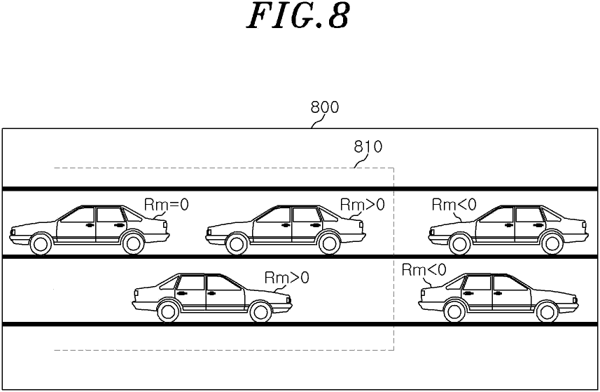

FIG. 8 is a diagram illustrating an operation of tracking an object using an observation zone by the traffic information predicting method according to an embodiment of the present disclosure.

Referring to FIG. 8, the frame 800 of the road image may include a zone used as a road. As such, an observation zone 810 may be set on the basis of the zone used as the road. If Rm<0, the object exists outside the observation zone. If Rm=0, the object passes through a boundary of the observation zone. If Rm>0, the object exists inside the observation zone.

Referring to FIGS. 7 and 8, in step S300, the traffic information predicting apparatus may check whether the object entering the observation zone 810 is detected over a predetermined number of frames, and assign an identifier (hereinafter referred to as a “tracking ID”) for tracking the object that is detected over the predetermined number of frames. In this case, in order for the traffic information predicting apparatus to check whether the object enters the observation zone, the counting of corresponding frames may be initiated when the object is changed from the state of Rm<0 to the state of Rm=0, and then it may be checked whether the object is detected over the predetermined number of frames when it is changed to the state of Rm>0. Further, the traffic information predicting apparatus may assign and manage the identifier (hereinafter referred to as a “tracking ID”) for tracking the detected object over the predetermined number of frames.

In step S400, the movement trajectory for the locations of the stored object using the tracking ID may be checked. Further, in step S500, the movement direction that is fit for the movement trajectory may be checked. Specifically, in step S500, the length of the movement trajectory may be preferentially checked. Further, the length of the movement trajectory may be compared with a predetermined threshold value, and a method of determining the movement direction on the basis of the compared result may be set. As an example, when the length of the movement trajectory exceeds the predetermined threshold value, the MOI trajectory-based determining method may be set. When the length of the movement trajectory does not exceed the predetermined threshold value, i.e. when the length of the movement trajectory is equal to or less than the predetermined threshold value, the MOI zone-based determining method may be set. Subsequently, the movement direction may be determined by the MOI trajectory-based determining method or the MOI zone-based determining method. An operation in which the movement direction is determined by the MOI trajectory-based determining method or the MOI zone-based determining method will be described in detail with reference to FIGS. 5A, 5B, 6A, or 6B.

In step S500, the number of vehicles for each movement direction may be counted on the basis of the movement direction that is checked in step S400. Preferably, the number of vehicles for each movement direction may be counted with respect to the observation zone. Specifically, the movement trajectory of the object for the vehicle may be tracked in the observation zone, as described above, and the number of corresponding objects may be counted with respect to time when they leave the observation zone. As such, by counting the number of the corresponding objects with respect to time when they leaves the observation zone, i.e. by counting the number of the objects in a state where the movement trajectory or the movement direction within the observation zone 410 has been confirmed, counting errors may be reduced. Further, by reducing the number of the objects being counted in a state where the movement direction has not been confirmed, it is possible to prevent unnecessary computing resources or memory capacity from being used for counting the number of the objects.

Further, in step S500, the number of vehicles for each confirmed movement direction may be stored and provided. For instance, there may be a device (e.g. traffic information management server, etc.) that processes traffic information using the number of vehicles for each movement direction and provides a traffic information service on the basis of the processed information, and the number of vehicles for each movement direction may be provided to these devices (e.g. traffic information management server, etc.).

Although it is illustrated in the traffic information predicting method according to an embodiment of the present disclosure that the number of vehicles for each movement direction is checked and the number of vehicles for each movement direction is provided to the above-described device (e.g. traffic information management server, etc.), the present disclosure may be variously changed without being limited thereto. For instance, in the traffic information predicting method, traffic congestion may be calculated using a result obtained by counting the number of vehicles for each movement direction. Further, in the traffic information predicting method, the traffic congestion may be provided to the above-described device (e.g. traffic information management server, etc.).

Moreover, in the traffic information predicting method, the number of vehicles for each movement direction as well as the type of vehicle may be provided, and the traffic information predicting apparatus or the device for providing the traffic information service may process the traffic information in consideration of both the number of vehicles for each movement direction and the type of vehicle.

Meanwhile, the traffic information predicting method according to an embodiment may be implemented by a computer readable recording medium storing a computer program programmed to perform steps included in the method, or a computer program stored in a computer readable recording medium programmed to perform the steps included in the method.

1. A method of predicting traffic information, the method comprising:
receiving a road image photographed by a vehicle that is moved on a road, and detecting an object for the vehicle from a plurality of frames included in the road image;
tracking the object detected in the plurality of frames;
checking a movement trajectory of the tracked object, and checking a movement direction corresponding to the movement trajectory of the object; and
checking a number of vehicles for each movement direction on the basis of the checked movement direction.

2. The method of claim 1, wherein the detecting the object for the vehicle includes extracting the plurality of frames among the frames, in consideration of a number of frames per second of the road image.

3. The method of claim 1, wherein the detecting the object for the vehicle includes inputing the plurality of frames to an object detection model trained with a plurality of training frames as an input dataset and an training object for a vehicle a s an label dataset, and checking the object for the vehicle output from the object detection model vehislees·en-output.

4. The method of claim 1, wherein the detecting the object for the vehicle further comprises outputting a type of vehicle of the detected object.

5. The method of claim 1, wherein the tracking the object includes tracking the object, on the basis of a detected location of the object that is continuously detected in each of the plurality of frames.

6. The method of claim 1, wherein the tracking the object includes setting an observation zone on the basis of a zone where the road exists in the plurality of frames.

7. The method of claim 6, wherein the tracking the object tracks the object existing in the observation zone.

8. The method of claim 1, wherein the checking the movement direction Includes:
checking a length of the movement trajectory; and
setting a method of determining the movement direction on the basis of the length of the movement trajectory.

9. The method of claim 8, wherein the setting the method of determining the movement direction on the basis of the length of the movement trajectory includes:
setting an MOI trajectory-based determining method of determining a movement direction on the basis of a Movement of Interest (MOI) trajectory, when a length of the movement trajectory exceeds a predetermined threshold value; and
setting an MOI zone-based determining method of determining a movement direction on the basis of an MOI zone, when the length of the movement trajectory does not exceed the predetermined threshold value.

10. The method of claim 9, wherein the checking the movement direction Includes:
checking a plurality of difference values between the movement trajectory and a plurality of predetermined MOI trajectories, according to the MOI trajectory-based determining method; and
checking an MOI trajectory having the smallest difference value from the movement trajectory, among the plurality of difference values, and determining a movement direction corresponding to the checked MOI trajectory as the movement direction.

11. The method of claim 9, wherein the checking the movement direction includes:
checking which MOI zone the object is located among a plurality of predetermined MOI zones, according to the MOI zone-based determination method; and
determining a movement direction corresponding to the MOI zone where the object is located as the movement direction.

12. The method of claim 1, further comprising:
providing the number of vehicles for each movement direction to a traffic information management server that performs a traffic information provision service.

13. The method of claim 1, further comprising:
checking traffic information using the number of vehicles for each movement direction; and
providing the traffic information to the traffic information management server that performs the traffic information provision service.

14. The method of claim 1, wherein the object detection model is a model that is trained to be operated in an edge computing environment.

15. An apparatus of predicting traffic information, the apparatus comprising:
a camera device capturing a road image in which a vehicle moving on a road is included;
a memory storing one or more instructions; and
a processor executing the one or more instructions stored in the memory, wherein the instructions, when executed by the processor, cause the processor to receive the road image and detecting an object for the vehicle from a plurality of frames included in the road image, track the object detected in the plurality of frames, check a movement trajectory of the tracked object and checking a movement direction corresponding to the movement trajectory of the object, and check a number of vehicles for each movement direction on the basis of the checked movement direction.

16. The apparatus of claim 15, wherein the processor is configured to input the plurality of frames to an object detection model trained with a plurality of training frames as an input dataset and an training object for a vehicle as an label dataset, and the object for the vehicle output from the object detection mode.

17. The apparatus of claim 15, wherein the processor is configured to detect the object for the vehicle and a type of the object for the vehicle, using an object detection model that takes the plurality of frames as an input and takes the object for the vehicle and the type of the object for the vehicle as an output.

18. The apparatus of claim 15, wherein the processor is configured to provide the number of vehicles for each movement direction to a traffic information management server that performs a traffic information provision service.

19. A non-transitory computer readable storage medium storing computer executable instructions, wherein the instructions, when executed by a processor, cause the processor to perform a method of predicting traffic information, the method comprising:
receiving a road image photographed by a vehicle that is moved on a road, and detecting an object for the vehicle from a plurality of frames included in the road image;
tracking the object detected in the plurality of frames;
checking a movement trajectory of the tracked object, and checking a movement direction corresponding to the movement trajectory of the object; and
checking a number of vehicles for each movement direction on the basis of the checked movement direction.

20. The non-transitory computer readable storage medium of claim 19, wherein the checking the movement direction Includes:
checking a length of the movement trajectory; and
setting a method of determining the movement direction on the basis of the length of the movement trajectory.
